(19) United States
(12) Patent Application Publication
(10) Pub. No.: US 2009/0056230 A1
(43) Pub. Date: Mar. 5, 2009

(54) Door Module With Integrated cable bundle

(76) Inventor: Joseph Gustaaf Flendrig, Brussels (BE)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 12/190,382

(22) Filed: Aug. 12, 2008

Related U.S. Application Data
(60) Provisional application No. 60/969,346, filed on Aug. 31, 2007.

(51) Int. Cl. B60J 5/04

(52) U.S. Cl. 49/502

(57) ABSTRACT

Door systems and core modules are provided. The core module can include a body having a cable tree disposed thereon and a recess formed in at least a portion thereof. The cable tree can extend from a perimeter of the body and can include one or more cables disposed therethrough. A reinforcement member can be disposed on the body from where the cable tree extends. The recess can be formed in at least a portion of the perimeter of the body. The recess can be adapted to receive at least a portion of the cable tree.

### RELATIONSHIP TO OTHER APPLICATIONS

This application claims priority to and benefit of U.S. Provisional Application Ser. No. 60/969,346, filed Aug. 31, 2007.

### FIELD OF THE INVENTION

Embodiments of the present invention generally relate to door systems. More particularly, embodiments of the present invention relate to door systems for vehicles, such as automobiles, namely cars and trucks.

### BACKGROUND OF THE INVENTION

Doors for automobiles contain many individual pieces that are assembled to a frame or shell. Automotive doors can have anywhere from fifty to more than one hundred individual components or parts depending on the vehicle and option package. Such components can include various hardware, electrical components, and seals. Hardware components typically include handles, mirrors, window regulators, window tracks, windows, door locks, and impact bolsters. Electrical components typically include wire harnesses, speakers, window motors, and outside mirror motors. Sealing components typically include glass run channels, beltline seals, lower sash seals, plugs, grommets, and body to door seals.

Such components are usually supplied by numerous vendors or suppliers. In most cases, an original equipment manufacturer (OEM) produces a door frame and exterior skin that are typically stamped separately from cold rolled steel, welded together, and painted to provide a door shell. In some cases, the frame and skin are stamped from one blank to form the door shell. The numerous individual components from the suppliers are then assembled onto the OEM's door shell, typically on the OEM's assembly line.

FIG. 1 shows a schematic illustration of a conventional door 100. Typical conventional doors 100 have an interior trim panel 110, inner panel 120, and outer panel 130. The inner panel 120 and outer panel 130 are usually formed from steel, stamped, welded together, and painted. The numerous hardware, electrical and sealing components such as those listed above (not shown in FIG. 1 for simplicity) are then assembled onto the steel inner panel 120. Similarly, the various components on the interior trim panel 110 including lights, switches, armrests, map pockets, handles, etc, (also not shown for simplicity) are assembled at a supplier and shipped to the OEM. The OEM attaches the assembled trim panel 110 to the assembled inner panel 120, and the final electrical and hardware connections are made.

Each component is attached to the door shell using at least one of many different means including clips, screws, fittings, adhesives, just to name a few. In most cases, twenty to forty five different assembly steps are needed to complete the entire assembly process of the door. Such assembly process is laborious and requires costly logistical considerations and/or systems to assure the right parts are at the right place at the right time. The assembly process can also demand a large amount of costly floor space.

Cost savings and part consolidation ideas have been tried; one of the more successful attempts included pre-assembled mounting panels with all or part of the hardware and electrical components assembled thereon as shown in FIG. 2. FIG. 2 shows a schematic illustration of a conventional door 200 having a pre-assembled mounting panel 210. The numerous components are assembled to the mounting panel 210, such as a window motor 215, window regulator 220, speaker 225, cables 230, just to name a few in addition to many other components or systems that communicate with other components or systems in a vehicle body.

Communication between the door components and vehicle body is typically done through a cable bundle or cable tree 235 that runs between the door and vehicle body. Since the door moves, i.e. swings, relative to the vehicle body, the cable tree 235 is flexible. To protect the cables from damage, dirt, water, and also to enhance the aesthetic appeal, the cables tree 235 is typically covered by a bellowed conduit 240.

All or part of the hardware and electrical components can be installed onto the mounting panel 210 at an outside supplier. Once the applicable components are assembled onto the mounting panel 210 at the outside supplier, the assembled mounting panel 210 is transported to the OEM for installation on a door panel sub-assembly or outer panel 250.

At the OEM, the cable tree 235 and the bellowed conduit 240 are threaded through a hole 260 located in the outer panel 250. The hole 260 is as small as possible to minimize the adverse effects on the strength and stiffness of the assembled door 200 as well as the aesthetic appeal thereof. Once the bellowed conduit 240 is threaded through the hole 260, an interior trim panel 270 is attached to the outer panel 250. Threading the conduit 240 through the hole 260 is a precision process that is time consuming and can be the cause of error and undue frustration.

Other part consolidation ideas are described in U.S. Pat. No. 6,857,688; U.S. Pat. No. 6,640,500; U.S. Pat. No. 6,546,674; U.S. Pat. No. 6,449,907; U.S. Pat. No. 5,820,191; U.S. Pat. No. 5,355,629; U.S. Pat. No. 5,040,335; U.S. Pat. No. 4,882,842; U.S. Pat. No. 4,648,208; and WO 01/25055 A1. However, in each of those systems the required assembly time of the door is substantially the same as in conventional systems, and such systems still require a cable tree to be threaded through a hole formed in the outer panel.

There is a need, therefore, for a door system that does not require threading a wiring system through a hole in an outer panel.

### SUMMARY OF THE INVENTION

Door system and core modules are provided. In at least one specific embodiment, the core module can include a body having one or more components disposed thereon and a cable tree disposed on the body. The cable tree can extend from a perimeter of the body and can include one or more cables disposed therethrough. A reinforcement member can be disposed on the body from where the cable tree extends. A notch can be formed in at least a portion of the perimeter of the body. The notch can be adapted to receive at least a portion of the cable tree.

In at least one specific embodiment, the door system can include an outer panel having a notch formed in a perimeter thereof, a core module, and a trim panel. The trim panel can be adapted to at least partially cover the core module. The core module can include a body having one or more components disposed thereon and a cable tree disposed on the body. The cable tree can extend from a perimeter of the body and can include one or more cables disposed therethrough. A reinforcement member can be disposed on the body from where the cable tree extends. A notch can be formed in at least a portion of the perimeter of the body and can be adapted to receive at least a portion of the cable tree.

In at least one specific embodiment, the door system can include an outer panel having a notch formed in a perimeter thereof, a core module, and a trim panel. The core module can include a body having one or more components disposed thereon and a cable tree disposed on the body. The cable tree can extend from a perimeter of the body and can include one or more cables therethrough. A reinforcement member can be disposed on the body from where the cable tree extends. The trim panel can include a notch formed in at least a portion of a perimeter of the trim panel. The recess can be adapted to receive at least a portion of the cable tree. The trim panel can be adapted to at least partially cover the core module.

### BRIEF DESCRIPTION OF THE DRAWINGS

FIG. 1 is a schematic illustration of a conventional door.

FIG. 2 is a schematic illustration of a conventional door having a pre-assembled mounting panel.

FIG. 3 is a schematic view of an illustrative outer panel according to one or more embodiments described.

FIG. 4 is a schematic view of an illustrative door assembly integrated with the outer panel of FIG. 3, according to one or more embodiments described.

FIG. 4A is a schematic view of a partially assembled illustrative door system, according to one or more embodiments described.

FIG. 4B is a schematic view of another partially assembled illustrative door system, according to one or more embodiments described.

FIG. 5 is a schematic view showing certain particulars of the trim panel of the integrated door assembly shown in FIG. 4, according to one or more embodiments described.

FIG. 6A depicts a simplified, partial side view of either a core module or trim panel having a recess formed in a forked protrusion thereof, according to one or more embodiments described.

FIG. 6B depicts a partial schematic of an illustrative bellowed conduit having a cable tree disposed therethrough, according to one or more embodiments described.

FIG. 6C depicts a simplified, partial side view of an outer panel having an opening or cut-out formed thereon, according to one or more embodiments described.

FIG. 6D depicts a simplified, partial side view of a bellowed conduit and cable tree of FIG. 6B disposed between the core module/trim panel shown in FIG. 6A and the outer panel shown in FIG. 6C, according to one or more embodiments described.

FIG. 7A depicts a simplified, partial side view of either a core module or trim panel having a recess or opening formed in the body thereof, according to one or more embodiments described.

FIG. 7B depicts a simplified partial side view of a bellowed conduit and cable tree of FIG. 7B disposed between the core module/trim panel of FIG. 7A and the outer panel shown in FIG. 6C, according to one or more embodiments described.

FIG. 8 depicts a schematic section type plan view of an illustrative door assembly through line A-A depicted in FIG. 5, according to one or more embodiments described.

FIG. 9 depicts a schematic section type plan view of another illustrative door assembly through line A-A depicted in FIG. 5, according to one or more embodiments described.

FIG. 10 depicts a schematic section type plan view of yet another illustrative door assembly through line A-A depicted in FIG. 5, according to one or more embodiments described.

FIG. 11 depicts a schematic section type plan view of still yet another illustrative door assembly through line A-A depicted in FIG. 5, according to one or more embodiments described.

FIG. 12 is a schematic view of an illustrative reinforcement, according to one or more embodiments described.

FIG. 13A is a schematic plan view of the reinforcement member shown in FIG. 12 having a cover plate attached thereto, according to one or more embodiments described.

FIG. 13B is a cross sectional view of an illustrative reinforcement member having one or more clips to secure a cover plate thereon, according to one or more embodiments described.

FIG. 13C is a cross sectional view of an illustrative reinforcement member having a profiled edge or protrusion formed thereon, according to one or more embodiments described.

FIG. 14A is a schematic view of an illustrative reinforcement member having one or more stiffening structures disposed thereon, according to one or more embodiments described.

FIG. 14B depicts an illustrative pattern of the one or more stiffening structures shown in FIG. 14A, according to one or more embodiments described.

FIG. 14C depicts another illustrative pattern of the one or more stiffening structures shown in FIG. 14A, according to one or more embodiments described.

FIG. 15A shows a schematic plan view of an illustrative reinforcement member, according to one or more embodiments described.

FIG. 15B shows a schematic plan view of another illustrative reinforcement member, according to one or more embodiments described.

FIG. 15C show a partial, enlarged schematic view of an illustrative insert for a reinforcement member, according to one or more embodiments described.

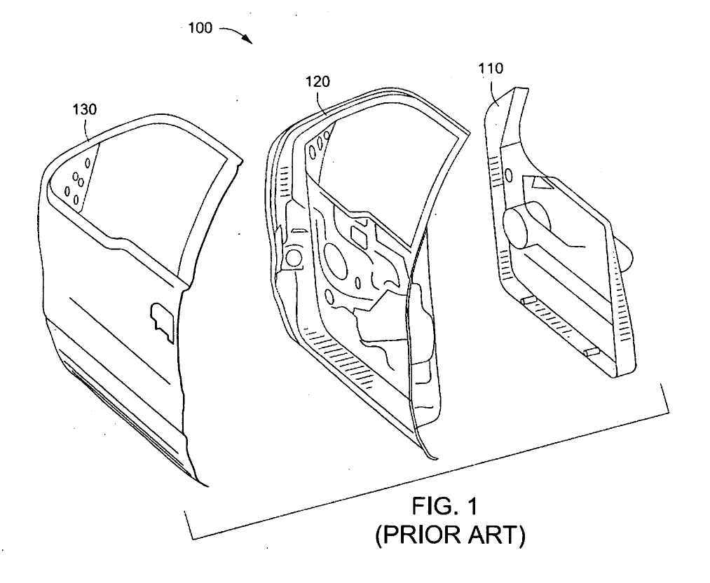

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information is combined with available information and technology.

Embodiments of the invention provide a door module having cable tree disposed on the body of the door core module. Embodiments also include a reinforcement member on the body from where the cable tree extends and a recess in a portion of the perimeter of the body that is adapted to receive at least a portion of the cable tree. In this way, embodiments of the invention provide a door assembly that does not require threading the cable tree through a hole in the outer panel of the door core module.

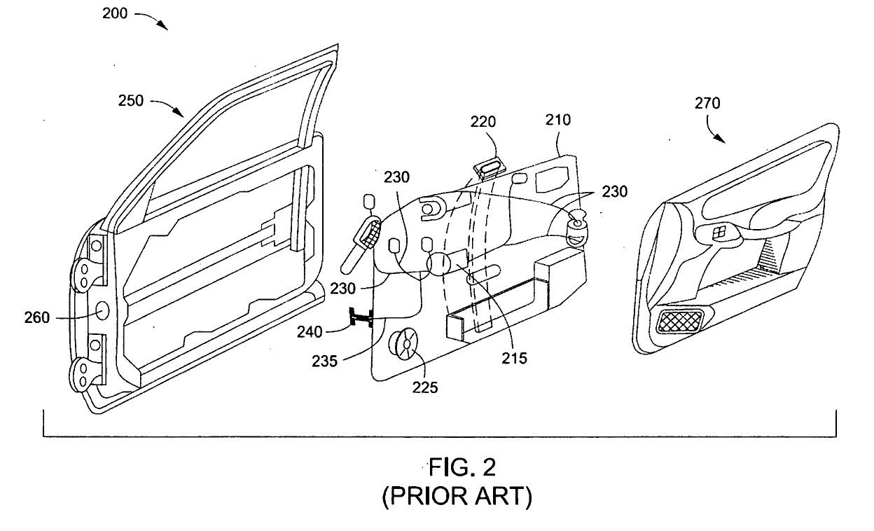

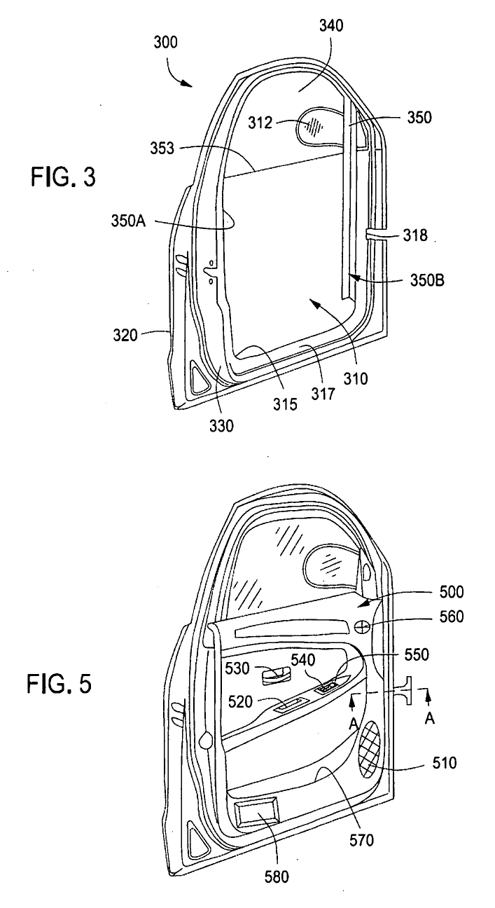

FIG. 3 is a schematic view of an illustrative outer panel 300 according to one or more embodiments described. The outer panel 300 has a first side or interior side 310 that faces the passenger compartment of the vehicle. The outer panel 300 also has a second side or exterior side to which a mirror 312 and external door handle (not shown in this view) can be attached. As used herein, the term “interior” refers to an orientation or direction facing toward the passenger compartment or inside of the vehicle, and the term “exterior” refers to an orientation or direction facing away from the passenger compartment or inside of the vehicle.

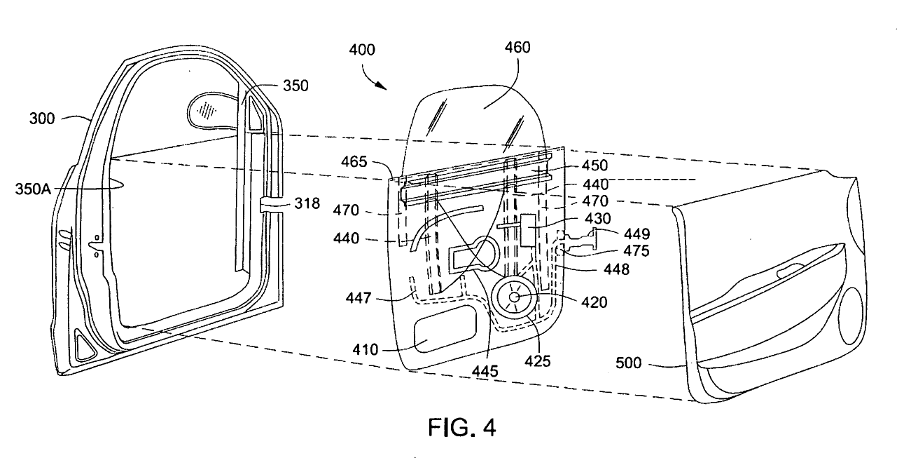

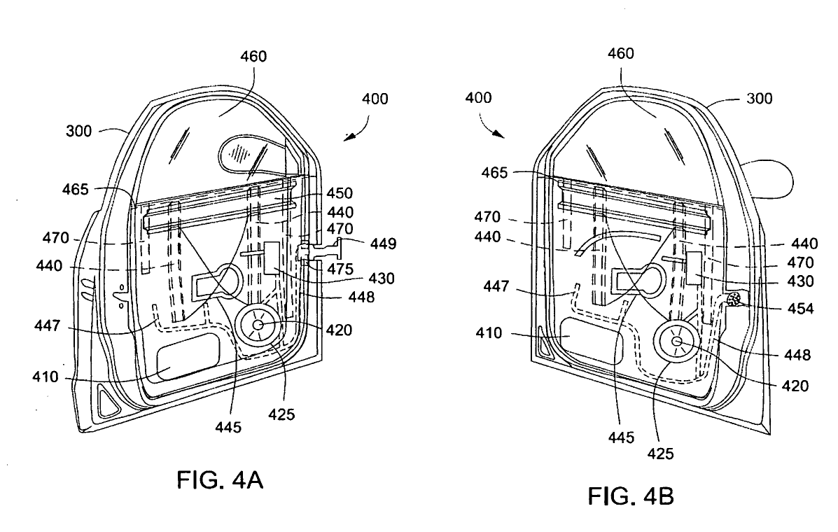

In one or more embodiments, the interior side 310 of the outer panel 300 can include a recessed cavity 315 forming a shoulder 317 about a perimeter of the outer panel 300. The shoulder 317 can have any depth and/or thickness to lend support to the outer panel 300 as required. At least a portion of the shoulder 317 can be removed to form a recess or notch 318. The recess 318 is an indentation in the shoulder 317 that provides a slot or guide for a cable tree 448 (shown in FIG. 4) and/or conduit 449 (also shown in FIG. 4) to be disposed therein without having to be threaded. The conduit 449 can be a flexible sheathing or housing, such as a bellowed conduit.

The recess 318, therefore, is unobstructed from the interior side of the outer panel 300, and can have any shape, size and profile. For example, an inner surface of the recess 318 can be rounded, elliptical, squared or rectangular. The recess 318 can be a cut-out or hollowed-out section from an outer surface of the outer panel 300. As mentioned above, the recess 318 can be at least partially taken from the shoulder 317 formed on the outer panel 300. The recess 318 can also be taken from the outer panel 300 itself. Further, the recess 318 can also be taken from a portion of the shoulder 317 and a portion of the outer panel 300.

Considering the outer panel 300 in more detail, the outer panel 300 can be fabricated from a single panel or two or more separate panels. In one or more embodiments, the outer panel 300 can include an outer skin 320 and an inner support 330 affixed to one another. In this embodiment, the inner support 330 defines the shoulder 317, and the recess 318 is removed or cut from a portion of the inner support 330.

In one or more embodiments, each of the outer skin 320 and the inner support 330 can be stamped from aluminum or cold, rolled steel, assembled, and painted or otherwise coated to meet the specifications of the OEM. In one or more embodiments, each of the outer skin 320 and the inner support 330 can be made from different types of steel (i.e. “tailored blanks”), welded together stamped and painted or otherwise coated as desired. Furthermore, the outer panel 300 can be a single component or single panel.

In one or more embodiments, the outer panel 300 can be fabricated from a non-metallic material. For example, the outer panel 300 can be injection molded from polyethylene, polypropylene and more preferably from a reinforced polypropylene. In certain one or more embodiments, each of the outer skin 320 and the inner support 330 can be injection molded, cast, extruded, molded or formed in any other way from one or more other suitable materials, including polyethylene, polypropylene, and/or any one or more materials described herein.

Still referring to FIG. 3, the outer panel 300 has an opening 340 formed in an upper portion thereof for the window glass (not shown). Within the opening 340, the outer panel 300 includes a seal or glass run channel 350 for mating engagement with the window glass when assembled. At least a portion of the glass run channel 350 extends into the cavity 315 of the outer panel 300 as shown. In one embodiment, a first portion 350A of the glass run channel 350 is attached to the outer panel 300 below the belt line 353 of the outer panel 300, and a second portion 350B thereof is attached at a lower end of the outer panel 300. Preferably, at least one of the first and second portions 350A, 350B of the glass run channel 350 has enough length to contact the window glass when the window glass is in a lowered position. More preferably, both the first and second portions 350A, 350B of the glass run channel 350 have a sufficient length to contact the window glass when the window glass is in a lowered position.

In one or more embodiments, the glass run channel 350 can be made from one or more separate sections or members that are fitted, welded, or otherwise attached together or kept in a fixed orientation relative to each other. Preferably, the glass run channel 350 is made from a single member. In one or more embodiments, the glass run channel 350 has one or more cross sections (i.e. profiles) adapted to contact the window glass. Illustrative profiles include “U” shaped, “L” shaped, and combinations thereof.

FIG. 4 is a schematic view of an illustrative door assembly integrated with the outer panel of FIG. 3, according to one or more embodiments described. As used herein the term “door” is intended to include any door on a vehicle. For example, the term “door” can refer to one or more passenger doors, whether hinged, sliding, lifting or with any other alternative opening/closing movement, lift gates, tail gates, and hatchbacks for any vehicle including cars, trucks, SUVs, motor homes, trains, boats, airplanes, tractors, buses, industrial vehicles, such as Caterpillar, whether for personal, recreational, or commercial use.

As shown in FIG. 4, the door system can include a core module 400 and trim panel 500 disposed on the outer panel 300. In one or more embodiments, the core module 400 can be attached to the outer panel 300 and the trim panel 500 can be attached to either the core module 400 or the outer panel 300 to complete the door system although any sequence can be used.

The core module 400 provides a body or substrate for one or more hardware components, electrical components, and sealing components to be attached to or otherwise assembled thereon. Illustrative components assembled to the core module 400 can include, but are not limited to one or more window regulators, motors, tracks, impact bolsters, wire harnesses, speaker boxes, speaker receptacles, reinforcement members, speakers, window motors, outside mirror motors, beltline seals, plugs, grommets, and core to frame seals. Such electrical and pneumatic components can require one or more wires or conduits to communicate with the vehicle body to which the door is attached. Such wires/conduits can be routed to a common location on the core module 400 and collected together as a cable tree or bundle 448. The cable tree 448 can be at least partially disposed within the bellowed conduit 449. In one or more embodiments, the bellowed conduit 449 can be a thin walled, hollow, corrugated tube. In one or more embodiments, the bellowed conduit 449 can have a wall thickness of about 0.5 mm to about 4 mm, about 1 mm to about 3 mm, or about 1.5 mm.

The terms “cable tree” and “cable bundle” are used synonymously herein and refer to one or more cables. The term “cable” as used herein refers to any conduit that can be used for communication, including a wire, optical fiber, coated optical fiber, Bowden cable, pneumatic line, and the like. Each cable can be insulated or not. It should further be noted that each cable can include two or more cables, i.e. a multi-stranded wire such as a fiber optic cable.

For simplicity and ease of illustration, the core module 400 is shown in FIG. 4 as having one or more bolsters or crash pads 410, speaker boxes 425, window tracks 440, motor supports 445, window glass 460, belt line seals 465, glass run channels 470, cable tree 448, and bellowed conduit 449. It is to be understood that the core module 400 can include any other component typical of an automotive door. For example, the core module 400 can include one or more speakers 420, door control units 430, and lock cables 447. The core module 400 can also include one or more air distribution channels for heating or air (not shown).

In one or more embodiments, the core module 400 can also include at least one reinforcement member (“first reinforcement member”) 450 disposed at an upper portion thereof. The first reinforcement member 450 adds strength and stiffness to the core module 400 and the overall door system when assembled. The first reinforcement member 450 can be disposed on either the interior side (“first side”) of the core module 400 or the exterior side (“second side”) of the core module 400. In FIG. 4, the first reinforcement member 450 is shown on the interior side of the core module 400, opposite the window tracks 440.

In one or more embodiments, the first reinforcement member 450 can be fabricated from a separate component and assembled onto the core module 400. For example, the first reinforcement member 450 can be fabricated from one or more metallic materials, such as steel or aluminum or from one or more non-metallic materials such as polypropylene or one or more engineering resins described below.

In one or more embodiments, the first reinforcement member 450 can be insert-molded with the core module 400. For example, the first reinforcement member 450 can be stamped from aluminum, steel, or other suitable metal or alloy, and inserted into the injection molding tool and at least partially over-molded with the core module 400 material. Preferably, the core module 400 and first reinforcement member 450 are integrally formed (i.e. insert molded) to reduce the number of components requiring assembly.

In one or more embodiments, the core module 400 can further include at least one reinforcement member (“second reinforcement member”) 475 disposed on a perimeter of the core module 400 from which the cable tree 448 extends. The second reinforcement member 475 can provide a rigid structure to support the recess 318 of the outer panel 300 when located adjacent thereto, thereby strengthening the outer panel 300 to which it is attached in the area of the cable tree 448. Accordingly, assembly of the core module 400 to the outer panel 300 is simplified by allowing a pure X-direction and Y-direction assembly of the core module 400 and the cable tree 448, significantly reducing the time of assembly. The term “Y-direction” as used herein refers to a direction perpendicular to the “X-direction,” where the X-direction is the driving direction of the vehicle.

Similar to the first reinforcement member 450, the second reinforcement member 475 can be fabricated from one or more metallic materials, such as steel or aluminum or from one or more non-metallic materials such as polypropylene or one or more engineering resins discussed below. In one or more embodiments, the second reinforcement member 475 can be fabricated from a separate component and assembled onto the core module 400. In one or more embodiments, the second reinforcement member 475 can be insert-molded with the core module 400. For example, the second reinforcement member 475 can be stamped from aluminum, steel, or other suitable metal or alloy, and inserted into the injection molding tool and at least partially over-molded with the core module 400 material.

The second reinforcement member 475 can be sized and designed to support the recess 318 created in the outer panel 300 to facilitate assembly of the core module 400 thereon. For example, to facilitate assembly of the core module 400 to the outer panel 300, the cable tree 448 and bellowed conduit 449 can be disposed or otherwise located within the recess 318 of the outer panel 300 with little manipulation. The core module 400 can then be secured or otherwise mounted to the outer panel 300. If used, the second reinforcement member 475 can be aligned or located on the core module 400 such that the second reinforcement member 475 can be arranged adjacent the recess 318 thereby providing a structural reinforcement to the outer panel 300. In other words, the second reinforcement member 475 can serve as a structural support for the compromised portion, i.e. the recess 318 of the outer panel 300.

The components of the core module 400 can be injection molded thereon. For example, the one or more bolsters 410, speaker boxes 425, window tracks 440, motor support 445, reinforcement member 450, belt line seal 465, glass run channels 470, and cable tree 448, and air distribution channels (not shown) can be integrally formed with the core module 400 using multi-material or multi-shot injection molding techniques. Multi-material injection molding techniques allow two or more materials to be injection molded into a single cavity mold or a multiple cavity mold. A three material process is commonly known as “3K.” Any suitable multi-material injection molding machine can be used, such as an Engel Victory Combi machine available from Engel Corp. Additional in-mold processing techniques can also be used to enhance and/or facilitate the integration. Illustrative in-mold processing techniques include, but are not limited to, multiple cavity tools, insert molding, movable core sections, and gas/water assist. Robotic extrusion can also be used alone or in combination with any of these processing techniques. Robotic extrusion is particularly useful for applying the sealing members into the injection mold.

In one or more embodiments, the glass run channels 470 can be 2K molded on the exterior side (“second side”) of the core module 400 using a multi-material injection molding machine. The second material is preferably flocked or slip coated to reduce friction with the window glass or the surface friction of the second material can be low enough to allow the glass to slide along it with acceptable force. Alternatively, the glass run channel 470 can be a separate member attached or otherwise assembled onto the core module 400.

Preferably, the glass run channels 470 are formed on the exterior side of the core module 400 and therefore shown in dashed lines in FIG. 4. The glass run channel 470 can have one or more profiles, such as “U” shaped, “L” shaped, or any combinations thereof, either alone or in combination with one or more lips, bulbs, or other sealing elements. The glass run channel 470 preferably has a shaped profile or at least one lip to match the “L” shaped profile of the lower portion 350A of the glass run channel 350 on the outer panel 300. As such, when the core module 400 is attached to the outer panel 300, the mating profiles of the glass run channels 350 and 470 provide a shaped guide for the window glass 460 to travel.

Still referring to FIG. 4, the one or more window tracks 440 can be located on the exterior side of the core module 400 with the glass run channels 470. As mentioned above, the one or more window tracks 440 can be integrated with the core module 400. Preferably, the window tracks 440 are injection molded on the core module 400. A slip coating (not shown in this view) can be inserted into the mold where the window tracks 440 are formed to reduce friction with the window glass. A slip coating can be inserted using the 2K or multi-material injection techniques or robotic extrusion. Alternatively, the slip coat can be inserted in the tool before the tracks 440 are molded. This can be done, for example, as a coating on a thin polymeric film. Alternatively, a thin polymeric film with a flock coating can be inserted into the tool and over-molded. The slip coating is preferably made of a material that can reduce friction between the window tracks 440 and the window glass. The slip coating can be made of polyethylene, polypropylene or other suitable materials, including the materials discussed herein. If the coefficient of friction of the base material from which the seal is made is low enough, it is no longer necessary to add a low friction surface to the seal.

In one or more embodiments, the component(s) can be inserted into an injection mold for making the core module 400. The core module 400 and the inserted components can be injection molded with a first material. A second material, such as a thermoplastic vulcanizate (TPV), can be injection molded to create the flexible components (seals, plugs, grommets, or soft touch portions of the skin) on the core module 400. Gas or water assist can also be used to create hollow profiles where needed for additional structure strength. Foaming agents can be used to create foam structures to minimize sink marks or to create a foam structure for increased stiffness. The core module 400 having the integrated components formed thereon is ejected from the tool. Any parts of the door that have not yet been integrated to the core module 400 can then be assembled. The window glass 460 can be assembled to the core module 400 last and properly adjusted. The core module 400 is then ready for delivery to the assembly line.

FIG. 4A is a schematic view of a partially assembled illustrative door system, according to one or more embodiments described. The core module 400 is shown attached or otherwise disposed on the outer panel 300. The trim panel 500 is not shown in this view so that the interior side of the assembled core module 400 can be seen. As shown, the bellowed conduit 449 can extend or otherwise protrude from the perimeter of the core module 400. A first end of the bellowed conduit 449 can have one or more plugs or connectors 454 for mating engagement to a corresponding plug or connector (not shown) disposed on the main car body (also not shown) to connect any cables or wires of the cable tree 448 therebetween. Any numbers not specifically described in FIG. 4A are as otherwise identified herein.

FIG. 4B is a schematic view of another partially assembled, illustrative door system, according to one or more embodiments described. Like FIG. 4A, the trim panel 500 is not shown in this view so that the interior side of the assembled core module 400 can be seen. In one or more embodiments, the cable tree 448 can terminate at the perimeter of the core module 400. The plug/connector 454 can be disposed on a first end of the cable tree 448 and can be located within the recess 318 on the door panel 300 so that when the core module 400 and/or the trim panel 500 is assembled, the plug/connector 454 can be held in place. A bellowed conduit can be located on the main car body (not shown) and the cable tree therethrough can be plugged into the counter plug 454 upon assembly. Any numbers not specifically described in FIG. 4B are as otherwise identified herein.

Considering the trim panel 500 in more detail, FIG. 5 is a schematic view showing certain particulars of the trim panel of the integrated door assembly shown in FIG. 4, according to one or more embodiments described. The trim panel 500 provides a housing or substrate for one or more electrical, mechanical, and/or sealing components to be attached or integrally molded, or insert molded thereto. Illustrative components include, but are not limited to air bags, air vents, switches, door handles, door locks, arm rests, map pockets, interior lights, speaker covers or grilles, speakers, beltline seals, plugs, grommets, and core to frame seals. Illustrative switches can be used for window glass control, window locks, outside mirror positioning controls, door locks, seat positioning controls, and stereo controls. As shown in FIG. 5, the trim panel 500 can further include one or more speaker covers 510, arm rests 520, door handle 530, window switches 540, door lock switches 550, side mirror controls 560, map pockets 570, and interior lights 580.

Preferably, the trim panel 500 is injection molded from one or more materials, such as polypropylene or the one or more engineering resins. In one or more embodiments, the arm rest 520, speaker cover 510, and map pocket 570 are injection molded on the trim panel 500 using multi-material or multi-shot injection molding techniques.

In one or more embodiments above or elsewhere herein, any one or all of the outer panel 300, core module 400, and trim panel 500 can include one or more seals, plugs, and/or grommets. Preferably, the one or more seals, plugs, and grommets are injection molded on the substrate or body (i.e. the outer panel 300, core module 400, or trim panel 500). Preferably, any one or more of the seals, plugs, and grommets are directly molded on the outer panel 300, core module 400, and/or trim panel 500 using two or three shot injection molding or robotic extrusion techniques. The integrated seals, plugs, and grommets can help prevent or eliminate water seepage, rattles, and vibration. Such components also increase the acoustical performance of the part (i.e. provide sound insulation and the “closing sound” of the door) while compensating for differences in part tolerance and expansion while allowing some movement.

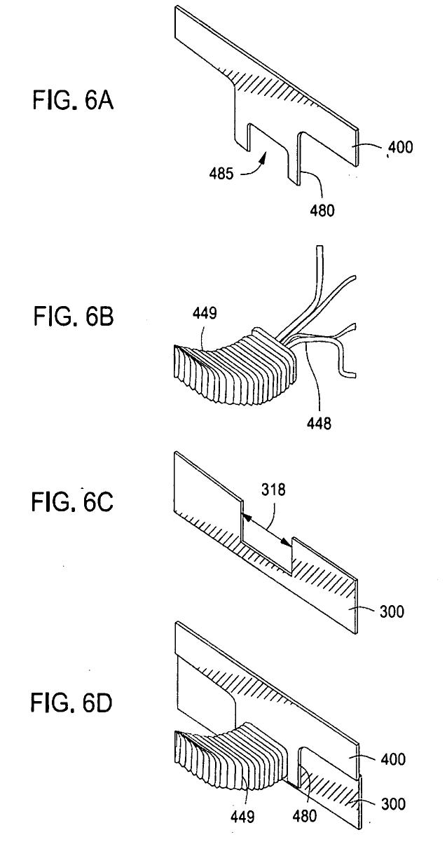

FIG. 6A shows a partial side view of either a core module 400 or trim panel 500 having a recess or opening 485 formed therein that corresponds to the recess 318 of the outer panel 300 (shown in FIG. 3). In the embodiment depicted, the recess 485 can be formed in a protrusion 480 extending from the body of the core module 400 or trim panel 500. As such, the protrusion 480 is forked (i.e. a “forked protrusion”). The recess 485 can be U-shaped and adapted to receive at least a portion of the cable tree 448 and bellowed conduit 449 as shown in FIG. 6B. FIG. 6C depicts a simplified, partial side view of the outer panel 300 having its recess 318 formed therein. In the embodiment depicted, the recess 318 has a U-shaped profile adapted to engage and receive the cable tree 448 and/or the bellowed conduit 449. FIG. 6D depicts a simplified, partial side view of the bellowed conduit 449 and cable tree 448 (shown in FIG. 6B) disposed between the core module 400/trim panel 500 (shown in FIG. 6A), and the outer panel 300 (shown in FIG. 6C). The bellowed conduit 449 can be friction fitted within the recess 485 of the forked protrusion 480 and the recess 318 of the outer panel 300 when the core module 400 is disposed thereon. Accordingly, the cable tree 448 and the bellowed conduit 449 can be at least partially disposed within the recess 485 and at least partially disposed within the recess 318. As such, the bellowed conduit 449 with the cable tree 448 at least partially disposed therethrough can be friction fitted between the panels 300 and 400, within the respective recesses or notches 318, 485, when the core module 400 is disposed on the outer panel 300.

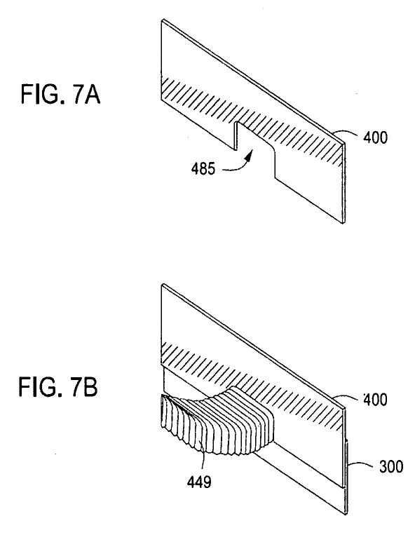

FIG. 7A depicts a simplified, partial side view of a core module or trim panel having a recess or opening formed in the body thereof, according to one or more embodiments. FIG. 7B depicts a simplified, partial side view of a bellowed conduit and cable tree of FIG. 6B disposed between the core module/trim panel shown in FIG. 7A and the outer panel 300 shown in FIG. 6C, according to one or more embodiments. As mentioned above, the recess 485 can be a notch or U-shaped profile, as depicted in FIG. 7A, formed in at least a portion of the perimeter of the core module 400 or trim panel 500. The cable tree 448 and the bellowed conduit 449 can be at least partially disposed within the recesses 318 and 485. In one or more embodiments, the cable tree 448 and the bellowed conduit 449 can be disposed within the recess 485, and friction fitted between the core module 400 and the recess 318 on the outer panel 300.

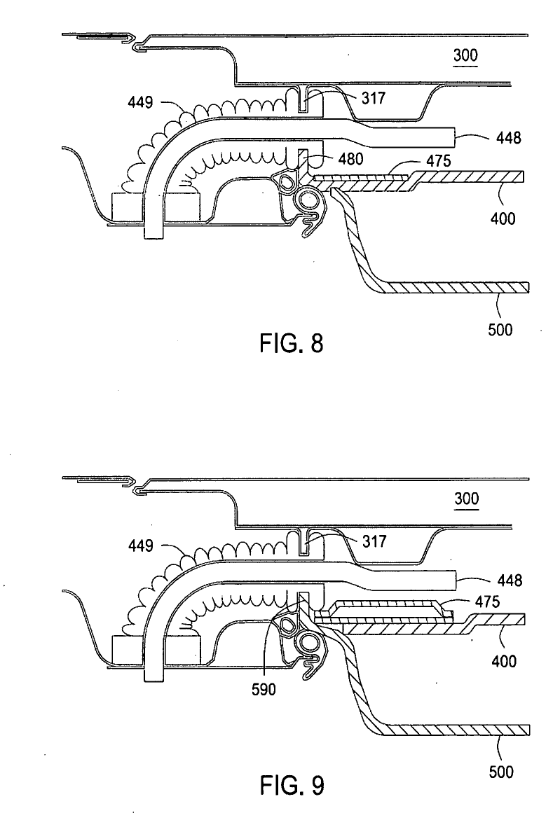

FIG. 8 depicts a schematic section type plan view of an illustrative door assembly through line A-A depicted in FIG. 5, according to one or more embodiments described. In FIG. 8, the cable tree 448 and bellowed conduit 449 are disposed and held in place between the outer panel 300 and the protrusion 480 on the core module 400. In this configuration, the cable tree 448 and bellowed conduit 449 are disposed and held within the recess 318 (not visible in this view) formed within a portion of the shoulder 317 of the outer panel 300 and the recess 485 formed in the protrusion 480 of the core module 400. The protrusion 480 secures the cable tree 448 and bellowed conduit 449 in place against the shoulder 317 of the outer panel 300. During assembly, the core module 400 is located about the outer panel 300 such that the second reinforcement member 475 aligns adjacent the opening 318 to provide additional structural support to the outer panel 300. The trim panel 500 can then be disposed on the core module 400 to complete the assembly of the door structure.

FIG. 9 depicts a schematic section type plan view of another illustrative door assembly through line A-A depicted in FIG. 5, according to one or more embodiments. In this embodiment, the cable tree 448 and bellowed conduit 449 can be held in place between the outer panel 300 and the trim panel 500. In one or more embodiments, the cable tree 448 and bellowed conduit 449 can be disposed within the recess 318 formed in a portion of the shoulder 317 of the outer panel 300 and securely held in place with the forked protrusion 590 on the trim panel 500. During assembly, the core module 400 can be disposed adjacent the outer panel 300 so that the second reinforcement member 475 can align with the opening 318 and provide additional structural support to the outer panel 300. The trim panel 500 can then be disposed on the core module 400 and the forked protrusion 590 on the trim panel 500 can secure the cable tree 448 and bellowed conduit 449 in place.

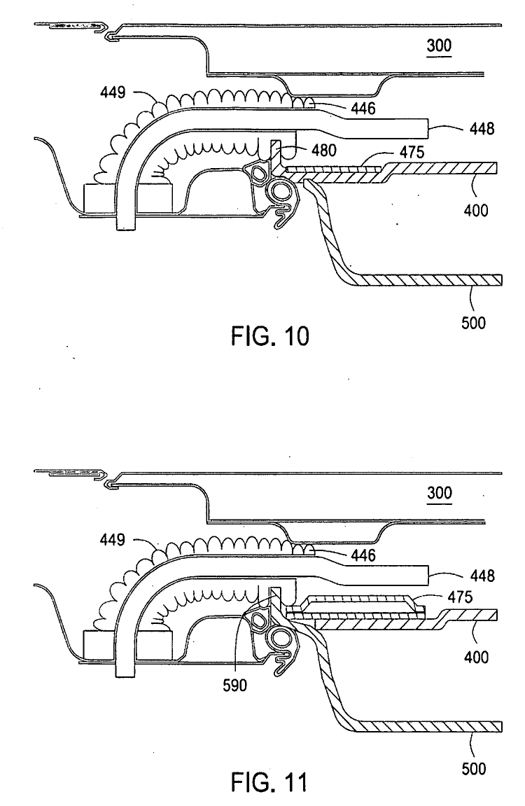

FIG. 10 depicts a schematic section type plan view of yet another illustrative door assembly through line A-A depicted in FIG. 5, according to one or more embodiments. In this configuration, the cable tree 448 and bellowed conduit 449 can be compressed or pinched, i.e. friction fitted between the outer panel 300 and the core module 400, thereby forming a seal therebetween. In this embodiment, the bellowed conduit 449 can be at least partially disposed within the recess 485 (not shown in this view) of the protrusion 480 of the core module 400 to prevent slippage or movement in the Y-direction. No opening 318 in the outer panel 300 is needed in this configuration. Instead, the first end 446 of the bellowed conduit 449 can create a seal against the outer panel 300 and the forked protrusion 480 of the core module 400. If needed, the second reinforcement member 475 can provide additional structural support to the overall assembly but is not required due to the absence of the opening 318.

In one or more embodiments, at least a portion of the first end 446 of the bellowed conduit 446 can have a different profile than the remaining portion of the bellowed conduit 449 or at least a portion of the first end 446 can have a greater wall thickness than the remaining portion of the bellowed conduit 449 to provide a better seal. For example, the first end 446 can be made from the same or a different material than the rest of the bellowed conduit 449. In one or more embodiments, the first end 446 can be produced by blow molding, injection blow molding, or injection molding.

FIG. 11 depicts a schematic section type plan view of still yet another illustrative door assembly through line A-A depicted in FIG. 5, according to one or more embodiments. In this configuration, the cable tree 448 and bellowed conduit 449 can be compressed or pinched, i.e. friction fitted between the outer panel 300 and the trim panel 500, thereby forming a seal therebetween. As mentioned above with regard to FIG. 10, at least a portion of the first end 446 of the bellowed conduit 449 can have a different profile or a greater wall thickness than the remaining portion of the bellowed conduit 449 to provide a better seal. In this embodiment, the bellowed conduit 449 can be at least partially disposed within the recess 585 (not shown in this view) of the forked protrusion 590 of the trim panel 500 to prevent slippage or movement in the Y-direction. No opening 318 in the outer panel 300 is needed in this configuration. Instead, the first end 446 of the bellowed conduit 449 can create a seal against the outer panel 300 and the forked protrusion 590 of the trim panel 500. If needed, the second reinforcement member 475 can be used to provide additional structural support to the overall assembly but is not required due to the absence of the opening 318.

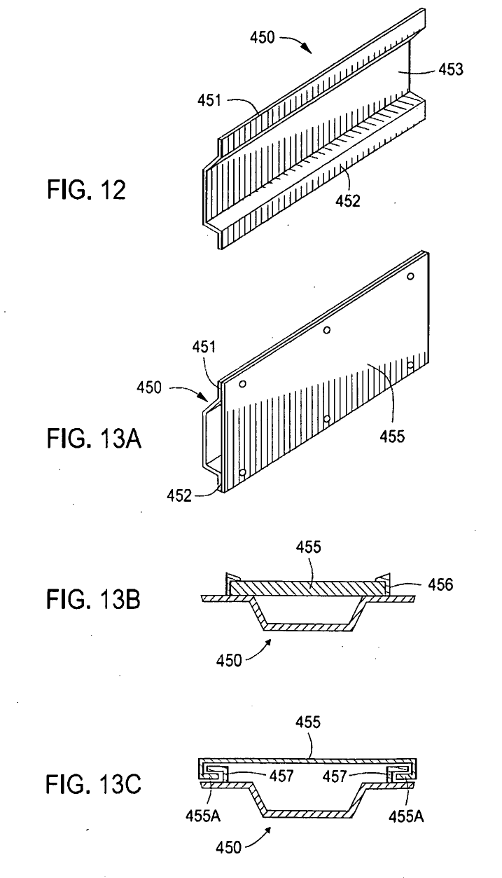

Considering the reinforcement members 450, 475 in more detail, FIGS. 12-15 depict various configurations of reinforcement members that can be used. The second reinforcement member 475 can be similar or identically designed as the first reinforcement member 450. The difference being the second reinforcement member 475 can be smaller and vertically aligned with relation to the core module 400 whereas the first reinforcement member 450 can be longer and disposed horizontally on the core module 400. For simplicity and ease of illustration, the following discussion is with reference to the larger, horizontally arranged first reinforcement member 450, but one can easily determine how to vertically align and scale down the first reinforcement member 450 to serve as the second reinforcement member 475. The size and shape of either reinforcement member 450, 475 can be easily determined, and is a matter of design and preference.

FIG. 12 is a schematic view of an illustrative reinforcement member 450 in accordance with one or more embodiments described. Referring to FIG. 12, the reinforcement member 450 can include a top flange 451 and a bottom flange 452. Although not shown in this view, each flange 451, 452 can include one or more apertures to receive one or more fastening member, such as a clip, screw, bolt, rivet, etc. In one or more embodiments, the reinforcement member 450 can include a recessed section 453 located between the flanges 451, 452, as shown in FIG. 12. The recessed section 453 can have any depth whether constant or variable. The depth helps provide stiffness (i.e. resistance against deformation).

In one or more embodiments above or elsewhere herein, the reinforcement member 450 can include a cover plate 455 disposed thereon to provide added strength and stiffness, as shown in FIG. 13A. FIG. 13A shows a schematic plan view of the reinforcement member 450 having the cover plate 455 attached thereto. The cover plate 455 is preferably secured to the reinforcement member 450 at the top and bottom flanges 451, 452. The cover plate 455 can be attached to the reinforcement member 450 using adhesion or any mechanical fastener including, for example, screws, bolts, rivets, clips, etc. The cover plate 455 can also be spot welded to the reinforcement member 450.

In one or more embodiments above or elsewhere herein, the cover plate 455 can be attached to the reinforcement member 450 using one or more clips 456 as shown in FIG. 13B. FIG. 13B shows a schematic cross sectional view of the reinforcement member 450 with one or more clips 456 to hold the cover plate 455 thereon. Preferably, the one or more clips 456 are injection molded or integrally formed with the reinforcement member 450 although the one or more clips 456 can be easily attached during assembly.

In one or more embodiments above or elsewhere herein, the cover plate 455 can slide onto the reinforcement member 450. For example, the cover plate 455 can include a profiled edge adapted to slide across a mating profiled edge of the reinforcement member 450, as shown in FIG. 13C. FIG. 13C shows a partial cross section of the reinforcement member 450 and cover plate 455 having profiled edges adapted to engage and slide thereabout. The profiled protrusion 457 of the reinforcement member 450 engages the profiled edge 455A of the cover plate 455, serving as a rail or guide for which the cover plate 455 can slide. Preferably, the clearance between the profiled edge 455A of the cover plate 455 and the profiled protrusion 457 of the reinforcement member 450 is just enough for the cover plate 455 to slide into place and be held in place without later vibrating or rattling during use.

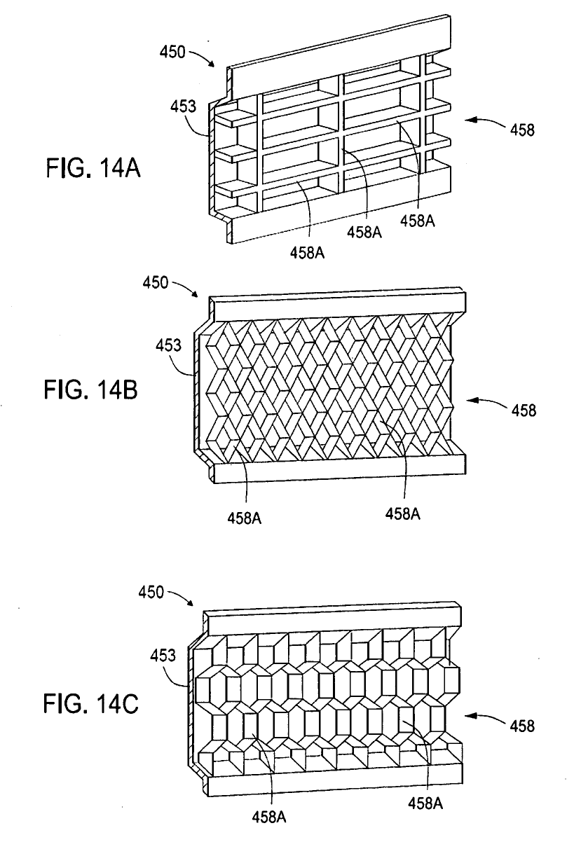

In one or more embodiments above or elsewhere herein, the reinforcement member 450 can include an insert or stiffening structure 458 disposed within the recessed section 453 as shown in FIG. 14A. FIG. 14A is a schematic view of an illustrative reinforcement member 450 having one or more inserts 458. Preferably, the insert 458 includes one or more fingers or ribs 458A that can be formed by over-molding a plastic structure within the recessed section 453 of the reinforcement member 450. The insert 458 increases resistance against deformation. The insert 458 can provide significantly higher energy absorption and resistance against buckling. After over-molding the insert 458, the cover plate 455 can be disposed thereon as explained above with reference to FIGS. 14A-14C, to provide additional strength.

In one or more embodiments above or elsewhere herein, the ribs 458A of the insert 458 can be arranged in various patterns as shown in FIGS. 14A-14C. For example, the ribs 458A can have a rectangular pattern to resemble a checker board as shown in FIG. 14A. In one or more embodiments, the ribs 458A can have a diamond-shaped pattern as shown in FIG. 14B. In one or more embodiments, the ribs 458A can have a honeycomb or polygonal pattern as shown in FIG. 14C. Other patterns include tubulars and circles. The desired pattern can depend on the stiffness and strength needed for the application and design considerations.

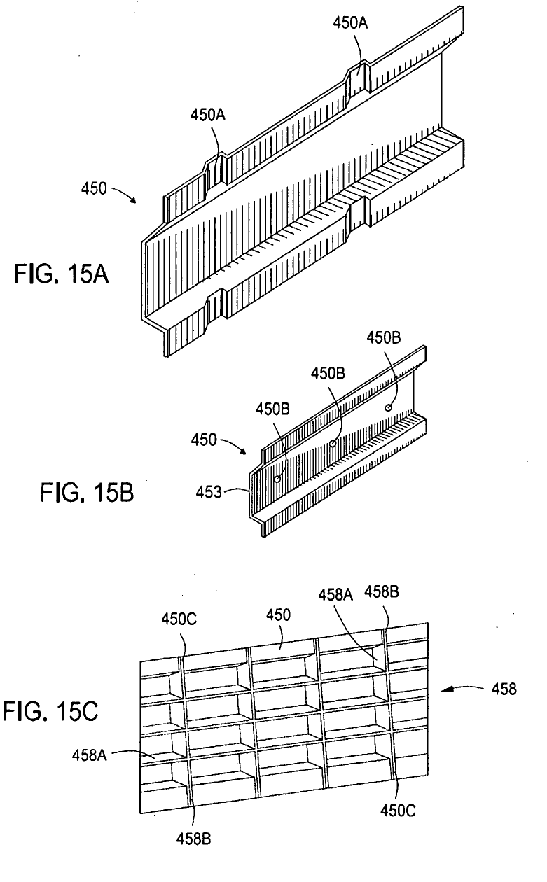

FIGS. 15A, 15B and 15C each show schematic plan views of an illustrative reinforcement member 450 having an insert disposed therein. Referring to FIGS. 15A-15C the insert 458 can be disposed within or otherwise attached to the recessed section 453 of the reinforcement member 450 using a variety of techniques. FIGS. 15A-15C each show illustrative plan views of a reinforcement member 450 having various ways to hold the insert 458. For example, the reinforcement member 450 can include one or more recesses or depressions 450A to provide a location or anchor for at least a portion of the insert 458, as shown in FIG. 15A. Accordingly, the insert 458 can include a mating protrusion (not shown) to fit within the depressions 450A of the reinforcement member 450, and contact the main body of the core module 400. As such, the insert 458 can be held in place during assembly. If the optional cover plate 455 is used, the insert 458 can be held in place with the depressions 450A until the cover plate 455 is secured into place.

In one or more embodiments above or elsewhere herein, one or more apertures 450B can be formed within the recessed section 453 of the reinforcement member 450, as shown in FIG. 15B. During the over-molding injection process the apertures 450B allow the material of the insert 458 to flow through the reinforcement member 450. As such, the material of the insert 458 is anchored within the reinforcement member 450 and secured in place.

In one or more embodiments above or elsewhere herein, the reinforcement member 450 can include one or more slits or openings 450C to receive a protruding feature 458B of the insert 458, as shown in FIG. 15C. The protruding feature 458B of the insert 458 can simply be an extension of one or more ribs 458A. The one or more slits 450C of the reinforcement member 450 can be biased or otherwise designed to provide a friction fit to hold the insert 458 in place.

In any of the embodiments described above with reference to FIGS. 15A-15C, the insert 458 can be held into place on the reinforcement member 450 and be ready for use. Alternatively, the insert 458 can be held into place on the first reinforcement member 450 for such length of time to allow a bonding adhesive of the cover plate 455 to reach sufficient strength, thereby relying on the cover plate 455 to hold the insert 458 in place during use. Further, the embodiments described allow the insert 458 to be held into place on the first reinforcement member 450 for such length of time to allow the cover plate 455 to be mechanically fastened to the reinforcement member 450 or the core module 400. Suitable mechanical fasteners include clip screws, heat stakes, rivets, blind rivets, and bolts, just to name a few. Spot welding can also be used.

In any of the embodiments above or elsewhere herein, hollow sections in the reinforcement members 450, 475 can be completely or partially filled with foam. This foam can be pre-foamed and shaped to fit in the desired hollow section and positioned. Assembly of the foam can be done by means of mechanical friction or mechanical undercut, adhesion system, mechanical fastener system, hot welding or other systems. The foam can also be foamed in place and attached to the reinforcement members 450, 475 by mechanical locking or by direct adhesion to the first reinforcement members 450, 475.

The first and second reinforcement members 450, 475 can be fabricated from separate components and assembled onto the core module 400. Preferably, the first and second reinforcement members 450, 475 are insert-molded with the core module 400. The first and second reinforcement members 450, 475 and the core module 400 can be made from the same material or the same combination of materials. The first and second reinforcement members 450, 475 and the core module 400 can also be made from different materials or a different combination of materials. Preferably, the first and second reinforcement members 450, 475 are injection molded in a two component process (“2K process”) with the core module 400. Suitable materials for the first and second reinforcement members 450, 475 and core module 400 are discussed in more detail below.

The components described, including the outer panel 300, glass run channels 350 and 470, core module 400, first reinforcement member 450, second reinforcement member 475, forked protrusion 480, trim panel 500, and forked protrusion 590 can be made from any material having the requisite properties, such as stiffness and strength for example. Suitable materials include, but are not limited to, propylene homopolymers, propylene copolymers, ethylene homopolymers, ethylene copolymers, and or any one or more of the following polymer resins: a) polyamide resins such as nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 (N6/66/610), nylon MXD6 (MXD6), nylon 6T (N6T), nylon 6/6T copolymer, nylon 66/PP copolymer, nylon 66/PPS copolymer; b) polyester resins such as polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer and other aromatic polyesters; c) polynitrile resins such as polyacrylonitrile (PAN), polymethacrylonitrile, acrylonitrile-styrene copolymers (AS), methacrylonitrile-styrene copolymers, methacrylonitrile-styrene-butadiene copolymers; and acrylonitrile-butadiene-styrene (ABS); d) polymethacrylate resins such as polymethyl methacrylate and polyethylacrylate; e) cellulose resins such as cellulose acetate and cellulose acetate butyrate; f) fluorine resins such as polyvinylidene fluoride (PVDF), polyvinyl fluoride (PVF), polychlorofluoroethylene (PCTFE), and tetrafluoroethylene/ethylene copolymer (ETFE); g) polyimide resins such as aromatic polyimides; h) polysulfones; i) polyacetals; j) polyactones; k) polyphenylene oxides and polyphenylene sulfides; l) styrene-maleic anhydrides; m) aromatic polyketones, n) polycarbonates (PC); o) elastomers such as ethylene-propylene rubber (EPR), ethylene propylene-diene monomer rubber (EPDM), styrenic block copolymers (SBC), polyisobutylene (PIB), butyl rubber, neoprene rubber, halobutyl rubber and the like); and p) mixtures of any and all of a) through o) inclusive.

In one or more embodiments above or elsewhere herein, the material can include one or more fillers for added strength. Fillers can be present in an amount of from 0.001 wt % to 50 wt % in one embodiment based upon the weight of the composition and from 0.01 wt % to 25 wt % in another embodiment, and from 0.2 wt % to 10 wt % in yet another embodiment. Desirable fillers include but are not limited to titanium dioxide, silicon carbide, silica (and other oxides of silica, precipitated or not), antimony oxide, lead carbonate, zinc white, lithopone, zircon, corundum, spinel, apatite, Barytes powder, barium sulfate, magnesiter, carbon black, graphite, dolomite, calcium carbonate, sand, glass beads, mineral aggregates, talc, and hydrotalcite compounds of the ions Mg, Ca, or Zn with Al, Cr or Fe and CO₃ and/or HPO₄, hydrated or not; quartz powder, hydrochloric magnesium carbonate, short glass fiber, long glass fiber, glass fibers, polyethylene terephthalate fibers, wollastonite, mica, carbon fiber, nanoclays, nanocomposites, magnesium hydroxide sulfate trihydrate, clays, alumina, and other metal oxides and carbonates, metal hydroxides, chrome, phosphorous and brominated flame retardants, antimony trioxide, silicone, and any combination and blends thereof. Other illustrative fillers can include one or more polypropylene fibers, polyamide fibers, para-aramide fibers (e.g. Kevlar or Twaron), meta-aramide fibers (e.g. Nomex), polyethylene fibers (e.g. Dyneema), and combinations thereof

The material can also include a nanocomposite, which is a blend of polymer with one or more organo-clays. Illustrative organo-clays can include one or more of ammonium, primary alkylammonium, secondary alkylammonium, tertiary alkylammonium, quaternary alkylammonium, phosphonium derivatives of aliphatic, aromatic or arylaliphatic amines, phosphines or sulfides or sulfonium derivatives of aliphatic, aromatic or arylaliphatic amines, phosphines or sulfides. Further, the organo-clay can be selected from one or more of montmorillonite, sodium montmorillonite, calcium montmorillonite, magnesium montmorillonite, nontronite, beidellite, volkonskoite, laponite, hectorite, saponite, sauconite, magadite, kenyaite, sobockite, svindordite, stevensite, vermiculite, halloysite, aluminate oxides, hydrotalcite, illite, rectorite, tarosovite, ledikite and/or florine mica.

When present, the organo-clay is preferably included in the nanocomposite at from 0.1 to 50 wt %, based on the total weight of the nanocomposite. The stabilization functionality may be selected from one or more of phenols, ketones, hindered amines, substituted phenols, substituted ketones, substituted hindered amines, and combinations thereof. The nanocomposite can further comprise at least one elastomeric ethylene-propylene copolymer, typically present in the nanocomposite at from 1 to 70 wt %, based on the total weight of the nanocomposite.

For areas, sections, or components of the door system 300 that need to provide structure, a reinforced polypropylene (PP) is preferred. Particularly preferred is a PP reinforced with a polyethylene-terethalate (PET) fiber or any other material that is light weight and provides a good balance of stiffness, impact strength, and has a low coefficient of linear thermal expansion (CLTE).

In one or more embodiments above or elsewhere herein, the polymer can be impact modified to provide improved impact resistance. Impact modifiers include, but are not limited to plastomers, ethylene propylene rubber (EPR), ethylene-propylene diene monomer rubber (EPDM), and may be used in combination with compatibilizers like, but not limited to maleated polypropylene, maleated polyethylene and other maleated polymers, hydroxilated polypropylene and other hydroxilated polymers, derivatives thereof, and any combination thereof.

In another embodiment, the material can contain a plastomer, preferably a propylene plastomer blend. The term “plastomer” as used herein refers to one or more polyolefin polymers and/or copolymers having a density of from 0.85 g/cm³ to 0.915 g/cm³ according to ASTM D4703 Method B or ASTM D 1505, and a melt index (MI) between 0.10 dg/min and 30 dg/min according to ASTM D 1238 at 190° C., 2.1 kg). Preferred plastomers have a melt index (MI) of between 0.10 dg/min and 20 dg/min in one embodiment, and from 0.2 dg/min to 10 dg/min in another embodiment, and from 0.3 dg/min to 8 dg/min in yet another embodiment as measured by ASTM D 1238. Preferred plastomers can have an average molecular weight of from 10,000 to 800,000 in one embodiment, and from 20,000 to 700,000 in another embodiment. The molecular weight distribution (Mw/Mn) of desirable plastomers ranges from 1.5 to 5 in one embodiment, and from 2.0 to 4 in another embodiment. The 1% secant flexural modulus (ASTM D 790) of preferred plastomers range from 10 MPa to 150 MPa in one embodiment, and from 20 MPa to 100 MPa in another embodiment. Further, a preferred plastomer has a melting temperature (Tm) of from 30° C. to 80° C. (first melt peak) and from 50° C. to 125° C. (second melt peak) in one embodiment, and from 40° C. to 70° C. (first melt peak) and from 50° C. to 100° C. (second melt peak) in another embodiment.

In one or more embodiments above or elsewhere herein, the plastomer can be a copolymer of ethylene derived units and at least one of a C3 to C10 α-olefin derived units. Preferably, the copolymer has a density less than 0.915 g/cm³. The amount of comonomer (C3 to C10 α-olefin derived units) present in the plastomer ranges from 2 wt % to 35 wt % in one embodiment, and from 5 wt % to 30 wt % in another embodiment, and from 15 wt % to 25 wt % in yet another embodiment, and from 20 wt % to 30 wt % in yet another embodiment.

In one or more embodiments above or elsewhere herein, the plastomer can be one or more metallocene catalyzed copolymers of ethylene derived units and higher α-olefin derived units, such as propylene, 1-butene, 1-hexene and 1-octene. Preferably, the plastomer contains enough of one or more of those comonomer units to yield a density between 0.860 g/cm³ and 0.900 g/cm³. Examples of commercially available plastomers include: EXACT 4150, a copolymer of ethylene and 1-hexene, the 1-hexene derived units making up from 18 wt % to 22 wt % of the plastomer and having a density of 0.895 g/cm³ and MI of 3.5 dg/min (available from ExxonMobil Chemical Company); and EXACT 8201, a copolymer of ethylene and 1-octene, the 1-octene derived units making up from 26 wt % to 30 wt % of the plastomer, and having a density of 0.882 g/cm³ and MI of 1.0 dg/min (available from ExxonMobil Chemical Company).

Preferred blends for use as the molded material herein typically include of from about 15%, 20% or 25% to about 80%, 90% or 100% polymer by weight; optionally of from about 0%, 5%, or 10% to about 35%, 40%, or 50% filler by weight, and optionally of from about 0%, 5%, or 10% to about 35%, 40%, or 50% plastomer by weight. In one or more embodiments, a preferred blend contains one or more polymers described in an amount ranging from a low of about 15%, 20% or 25% to a high of about 80%, 90% or 100% polymer by weight. In one or more embodiments, a preferred blend contains at least about 1%, 5%, 10%, 15%, or 20% plastomer by weight. In one or more embodiments, a preferred blend contains at least about 1%, 5%, 10%, 15%, or 20% filler by weight.

Preferably, blends for use herein will have a tensile strength of at least 6,500 MPa, at least 7,500 MPa, or at least 9,000 MPa. Further, preferred blends will have a flexural modulus of 1,750 MPa or more, such as about 1,800 MPa or more, or more than about 2,000 MPa.

In addition to the materials and polymers described above, one or more thermoplastic vulcanizates (TPV), thermoplastic elastomer (TPE), thermoplastic olefin (TPO), polyurethanes (PU), or elastomers such as EPR or EPDM can be used for areas or components that need to have sealing properties. Those material can be used in dense (non-foamed) or in foamed state. Most preferably, a TPV is selected due to the inherent mechanical properties that provide excellent sealing capability and the ability to be injection molded. The other aspect of materials will be the compatibalization of the structural and sealing materials, or the ability to adhere to each other. The materials of either the structural and/or sealing systems can be functionalized or have a secondary additive or component added to the material to provided good bondability.

As noted above, the degree of integration described can dramatically reduce the cost and assembly complexity of the finished door. Logistical costs, for example, are also significantly reduced, which reduces the amount of assembly errors in addition to the overall cost. Functional testing costs after final assembly are also reduced or eliminated because a majority of the functionality can be tested prior to final assembly (i.e. pre-tested). Further, the use of plastic materials in the door assembly can provide lower overall weight, more part integration, improved noise insulation, greater design freedom and will enable cheaper design modifications (i.e. using replaceable inserts in an injection molding tool).

The multi-material injection molding techniques described can also provide a unique combination of materials. Further, the number of secondary attachment techniques needed for multiple components such as rivets, screws, adhesives, clips, snaps, etc, is greatly reduced, if not eliminated all together in some instances.

Embodiments of the present invention further relate to:
1. A core module, comprising:
   a body having one or more components disposed thereon;
   a cable tree disposed on the body and extending from a perimeter thereof, the cable tree comprising one or more cables disposed therethrough;
   a reinforcement member disposed on the body from where the cable tree extends; and
   a recess formed in at least a portion of the perimeter of the body, the recess adapted to receive at least a portion of the cable tree.
2. The core module according to paragraph 1, wherein the one or more components are integrally formed on the body, and injection molded from polypropylene.
3. The core module according to paragraphs 1 or 2, wherein the reinforcement member comprises a first flange, a second flange, a recessed portion between the flanges, and an insert disposed within the recessed portion, the insert comprising one or more stiffening members.
4. The core module according to any of paragraphs 1 to 3, wherein the one or more components comprises a window regulator, window track, window glass, window switches, door lock, door handle, door lock switch, arm rest, map pocket, impact bolster, wire harness, speaker, window motor, outside mirror motor, plug, grommet, seal, sound insulation, or combinations thereof.
5. The core module according to any of paragraphs 1 to 4, wherein the cable tree is at least partially disposed within a bellowed conduit.
6. The core module according to any of paragraphs 1 to 5, wherein the body is injection molded from one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.
7. The core module according to any of paragraphs 1 to 6, wherein the body is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer, polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and blends thereof
8. The core module according to any of paragraphs 1 to 7, wherein at least a portion of the bellowed conduit is friction fitted within the recess in the body.
9. A core module, comprising:
   a body having one or more components disposed thereon;
   a cable tree disposed on the body and extending from a perimeter thereof, the cable tree comprising one or more cables disposed therethrough;
   a first reinforcement member disposed on the body from where the cable tree extends;
   a second reinforcement member disposed on an upper portion of the body; and
   a recess formed in at least a portion of the perimeter of the body, the recess adapted to receive at least a portion of a bellowed conduit having at least a portion the cable tree disposed therethrough.
10. The core module according to paragraph 9, wherein the body is injection molded from one or more resins selected from the group consisting of polypropylene, polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.
11. A door system, comprising:
   an outer panel having a recess formed in a perimeter thereof;
   a core module comprising:
      a body having one or more components disposed thereon;
      a cable tree disposed on the body and extending from a perimeter thereof, the cable tree comprising one or more cables disposed therethrough;
      a reinforcement member disposed on the body from where the cable tree extends; and
      a recess formed in at least a portion of the perimeter of the body, the recess adapted to receive at least a portion of the cable tree; and
      a trim panel adapted to at least partially cover the core module.
12. The door system according to paragraph 11, wherein the recess in the outer panel is an indentation formed in the perimeter of the outer panel.
13. The door system according to paragraphs 11 or 12, wherein the one or more components are integrally formed on the body, and injection molded from polypropylene.
14. The door system according to any of paragraphs 11 to 13, wherein the reinforcement member comprises a first flange, a second flange, a recessed portion between the flanges, and an insert disposed within the recessed portion, the insert comprising one or more stiffening members.
15. The door system according to any of paragraphs 11 to 14, wherein the one or more components comprises a window regulator, window track, window glass, window switches, door lock, door handle, door lock switch, arm rest, map pocket, impact bolster, wire harness, speaker, window motor, outside mirror motor, plug, grommet, seal, sound insulation, or combinations thereof.
16. The door system according to any of paragraphs 11 to 15, wherein the cable tree is at least partially disposed within a bellowed conduit.
17. The door system according to any of paragraphs 11 to 16, wherein the body comprises polypropylene.
18. The door system according to any of paragraphs 11 to 17, wherein the body is injection molded from polypropylene.
19. The door system according to any of paragraphs 11 to 18, wherein the body comprises one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.
20. The door system according to any of paragraphs 16 to 19, wherein the recess of the outer panel has a U-shaped profile, and the recess of the core module comprises a mating U-shaped profile.
21. The door system according to any of paragraphs 11 to 20, wherein the recess of the outer panel and the recess of the core module are adapted to form a seal about the bellowed conduit when engaged with one another.
22. The door system according to any of paragraphs 11 to 21, wherein the bellowed conduit is at least partially disposed within the recesses of the outer panel and the core module.
23. The door system according to any of paragraphs 11 to 22, wherein the core module is disposed on the outer panel, securing the bellowed conduit within the recesses of the outer panel and the core module.
24. A door system, comprising:
   an outer panel having a recess formed in a perimeter thereof,
   a core module comprising:
      a body having one or more components disposed thereon;
      a cable tree disposed on the body and extending from a perimeter thereof, the cable tree comprising one or more cables disposed therethrough; and
      a reinforcement member disposed on the body from where the cable tree extends; and
   a trim panel comprising a recess formed in at least a portion of a perimeter of the trim panel, wherein the recess is adapted to receive at least a portion of the cable tree, and the trim panel is adapted to at least partially cover the core module.
25. A core module, comprising:
   a body having one or more components disposed thereon;
   a cable tree disposed on the body and terminating with a connector plug at a perimeter thereof, the cable tree comprising one or more cables disposed therethrough;
   a reinforcement member disposed on the body from where the cable tree terminates with the connector plug; and
   a recess formed in at least a portion of the perimeter of the body, the recess adapted to receive at least a portion of the connector plug.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents, including priority documents, cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A core module, comprising:
a body having one or more components disposed thereon;
a cable tree disposed on the body and extending from a perimeter thereof, the cable tree comprising one or more cables disposed therethrough;
a reinforcement member disposed on the body from where the cable tree extends; and
a recess formed in at least a portion of the perimeter of the body, the recess adapted to receive at least a portion of the cable tree.

2. The core module of claim 1, wherein the one or more components are integrally formed on the body and injection molded from polypropylene.

3. The core module of claim 1, wherein the reinforcement member comprises a first flange, a second flange, a recessed portion between the flanges, and an insert disposed within the recessed portion, the insert comprising one or more stiffening members.

4. The core module of claim 1, wherein the one or more components comprises a window regulator, window track, window glass, window switches, door lock, door handle, door lock switch, arm rest, map pocket, impact bolster, wire harness, speaker, window motor, outside mirror motor, plug, grommet, seal, sound insulation, or combinations thereof.

5. The core module of claim 1, wherein the cable tree is at least partially disposed within a bellowed conduit.

6. The core module of claim 1, wherein the body is injection molded from one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.

7. The core module of claim 1, wherein the body is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer, polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and blends thereof.

8. The core module of claim 5, wherein at least a portion of the bellowed conduit is friction fitted within the recess in the body.

9. A core module, comprising:
a body having one or more components disposed thereon;
a cable tree disposed on the body and extending from a perimeter thereof, the cable tree comprising one or more cables disposed therethrough;
a first reinforcement member disposed on the body from where the cable tree extends;
a second reinforcement member disposed on an upper portion of the body; and
a recess formed in at least a portion of the perimeter of the body, the recess adapted to receive at least a portion of a bellowed conduit having at least a portion the cable tree disposed therethrough.

10. The core module of claim 9, wherein the body is injection molded from one or more resins selected from the group consisting of polypropylene, polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.

11. A door system, comprising:
an outer panel having a recess formed in a perimeter thereof;
a core module comprising:
a body having one or more components disposed thereon;
a cable tree disposed on the body and extending from a perimeter thereof, the cable tree comprising one or more cables disposed therethrough;
a reinforcement member disposed on the body from where the cable tree extends; and
a recess formed in at least a portion of the perimeter of the body, the recess adapted to receive at least a portion of the cable tree; and
a trim panel adapted to at least partially cover the core module.

12. The door system of claim 11, wherein the recess in the outer panel is an indentation formed in the perimeter of the outer panel.

13. The door system of claim 11, wherein the one or more components are integrally formed on the body, and injection molded from polypropylene.

14. The door system of claim 11, wherein the reinforcement member comprises a first flange, a second flange, a recessed portion between the flanges, and an insert disposed within the recessed portion, the insert comprising one or more stiffening members.

15. The door system of claim 11, wherein the one or more components comprises a window regulator, window track, window glass, window switches, door lock, door handle, door lock switch, arm rest, map pocket, impact bolster, wire harness, speaker, window motor, outside mirror motor, plug, grommet, seal, sound insulation, or combinations thereof.

16. The door system of claim 11, wherein the cable tree is at least partially disposed within a bellowed conduit.

17. The door system of claim 11, wherein the body comprises polypropylene.

18. The door system of claim 11, wherein the body is injection molded from polypropylene.

19. The door system of claim 11, wherein the body comprises one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.

20. The door system of claim 11, wherein the recess of the outer panel has a U-shaped profile, and the recess of the core module comprises a mating U-shaped profile.

21. The door system of claim 20, wherein the recess of the outer panel and the recess of the core module are adapted to form a seal about the bellowed conduit when engaged with one another.

22. The door system of claim 11, wherein the bellowed conduit is at least partially disposed within the recesses of the outer panel and the core module.

23. The door system of claim 11, wherein the core module is disposed on the outer panel, securing the bellowed conduit within the recesses of the outer panel and the core module.

24. A door system, comprising:
an outer panel having a recess formed in a perimeter thereof,
a core module comprising:
a body having one or more components disposed thereon;
a cable tree disposed on the body and extending from a perimeter thereof, the cable tree comprising one or more cables disposed therethrough; and
a reinforcement member disposed on the body from where the cable tree extends; and
a trim panel comprising a recess formed in at least a portion of a perimeter of the trim panel, wherein the recess is adapted to receive at least a portion of the cable tree, and the trim panel is adapted to at least partially cover the core module.

25. A core module, comprising:
a body having one or more components disposed thereon;
a cable tree disposed on the body and terminating with a connector plug at a perimeter thereof, the cable tree comprising one or more cables disposed therethrough;
a reinforcement member disposed on the body from where the cable tree terminates with the connector plug; and
a recess formed in at least a portion of the perimeter of the body, the recess adapted to receive at least a portion of the connector plug.
